(19) United States
(12) Patent Application Publication
(10) Pub. No.: US 2017/0072233 A1
(43) Pub. Date: Mar. 16, 2017

(54) SAFETY TIE OFF FOR A MAN LIFT

(71) Applicant: Eric Keiser, Wapakoneta, OH (US)

(72) Inventor: Eric Keiser, Wapakoneta, OH (US)

(21) Appl. No.: 14/851,486

(22) Filed: Sep. 11, 2015

(51) Int. Cl. A62B 35/00; G05B 9/02

(52) U.S. Cl. CPC A62B 35/0068; G05B 9/02

(57) ABSTRACT

A safety system for a man lift including: a loop connector attached to the man lift; a sensor within the loop connector, where sensor detects attachment of a lanyard clip; and a control system for the man lift, where the sensor is integrated into the control system and said sensor enables the control system upon attachment of a lanyard clip to the loop connector. The loop connector may be attached to a basket of the man lift and preferably the loop connector is attached to the frame of the basket.

### BACKGROUND OF THE INVENTION

Field of Invention

The present invention relates to a safety tie off system sensor for a man lift.

Description of Related Art

Individuals in construction and industrial facilities typically use man lifts to elevate an individual to a suitable height to perform a task. Typically a man lift is on four wheels and includes an extension that holds a basket that the individual stands in while being elevated. The individual within the basket usually has controls to maneuver the basket to the appropriate height and position to perform whatever task needed. The man lift elevates individuals to various heights in the air depending on the application and parameters. The individual within the basket has a serious fall risk from the basket and therefore normally encouraged to wear some type of lanyard or other attachment tie off such as the body harness that ties to the basket to ensure that the individual doesn't fall out of or from the basket while performing their task. However most of these baskets do not have any safety switches to ensure that the individual is actually tied off properly before operating the man lift. Further, the rails on the basket are occasionally low and increase the risk of an individual falling from the basket. As a result, it would be advantageous to have a safety system implemented into a man lift that requires the individual to tie off properly before operation is enabled.

### SUMMARY OF THE INVENTION

The present invention relates to a safety system for a man lift including: a loop connector attached to the man lift; a sensor within the loop connector, where sensor detects attachment of a lanyard clip; and a control system for the man lift, where the sensor is integrated into the control system and said sensor enables the control system upon attachment of a lanyard clip to the loop connector. The loop connector may be attached to a basket of the man lift and preferably the loop connector is attached to the frame of the basket.

### BRIEF DESCRIPTION OF DRAWINGS

FIG. 1 depicts a safety switch and sensor used with a lanyard in accordance with the present invention.

FIG. 2 depicts a man lift that has a safety switch and sensor installed within the basket of the man lift.

### DETAILED DESCRIPTION

The present invention relates to a safety system tie off sensor that is used to ensure that an individual ties off within a man lift before performing any tasks. The tie off system according to the present invention includes a safety switch that is installed in the basket that includes a sensor to detect the attachment of a lanyard clip within the sensor. The sensor is integrated within a control system of the man lift and disables the man lift until a tie off lanyard is attached within the switch. This system ensures that an individual ties off properly prior to operation of the man lift.

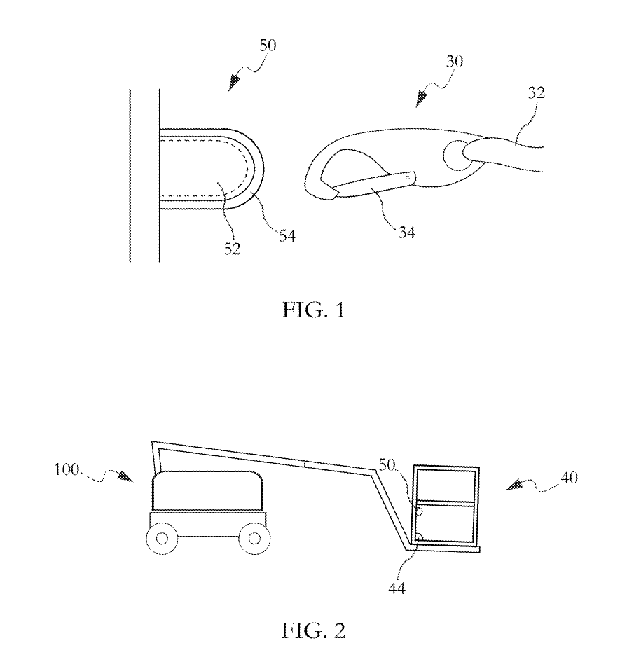

FIG. 1 depicts a safety switch with sensor in accordance with the present invention. The Safety Switch 50 includes a Sensor 52 within a Loop Connector 54. Preferably, the Loop Connector 54 attaches to a Frame 42 of a Basket 40 shown in FIG. 2. FIG. 1 shows a close up of the Safety Switch 50 and next to the Safety Switch 50 a Lanyard 32 is shown with a Latch 30. The Latch 30 has a Clip 34 that allows for the attachment of the latch into the Loop Connector 54. Once connected within the Loop Connector 54, the Sensor 52 is activated and therefore enables the control system for a man lift.

An overall view of a Man Lift 100 is shown in FIG. 2. The Man Lift 100 includes a Basket 40, where a Frame 42 includes the Safety Switch 50 shown in FIG. 1. The Safety Switch 50 ensures that the user of the man lift has it tied into the Safety Switch 50 prior to operation. The Basket 40 also includes a foot pedal that is disabled until the Sensor 52 is activated upon the attachment of a lanyard as shown and depicted in FIG. 1. As a result, this system is essentially a cut off system that ensures that an individual is properly tied off in the basket of the man lift prior to operation. The instant invention has been shown and described in what it considers to be the most practical and preferred embodiments. It is recognized, however, that departures may be made there from within the scope of the invention and that obvious modifications will occur to a person skilled in the art.

What is claimed is:

1. A safety system for a man lift comprising:
a. a loop connector attached to the man lift;
b. a sensor within the loop connector, where sensor detects attachment of a lanyard clip; and
c. a control system for the man lift, where the sensor is integrated into the control system and said sensor enables the control system upon attachment of a lanyard clip to the loop connector.

2. The safety system according to claim 1, where the loop connector is attached to a basket of the man lift.

3. The safety system according to claim 2, where the loop connector is attached to the frame of the basket.
